(19) United States
(12) Patent Application Publication
(10) Pub. No.: US 2010/0159144 A1
(43) Pub. Date: Jun. 24, 2010

(54) ANTICORROSIVE LAYER ON METAL SURFACES

(75) Inventors: Burkhard Standke, Lorrach (DE); Christian Wassmer, Hausen (DE); Peter Jenkner, Wesel (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/161,112

(22) PCT Filed: Dec. 28, 2006
(86) PCT No.: PCT/EP2006/070261

§ 371 Date: Jul. 16, 2008

(30) Foreign Application Priority Data
Jan. 26, 2006 (DE) 10 2006 003 956.4

(51) Int. Cl. B05D 3/02

(52) U.S. Cl. 427/387

(57) ABSTRACT

The present invention provides a new corrosion control coating for metals, a process for preparing it, and its use.

The present invention relates to a new corrosion control coating for metal, to a process for preparing it, and to its use.

Silanes are attracting increasing interest as starting materials in the production of nano composites by the sol-gel process: inter alia EP 1 288 245 A, EP 0 982 348 A, DE 198 16 136 A, WO 99/036359. Nanocomposites of this kind are commonly used as coating materials for any of a very wide variety of applications.

Additionally, well-established coating materials include a very wide variety of surface-coating materials, not least, more particularly, for the purpose of protecting metals from corrosion. In auto making, more particularly, it is common to use not just one coating film to protect the bodywork.

A frequent and major disadvantage of known coating systems based on sol-gel formulations is the presence of chloride and a high fraction of organic, generally volatile and also toxic solvents, which are obtained as a by product of the hydrolysis of the silanes or are added as diluents. The use of an amount of water insufficient for full hydrolysis of the silanes, and the utilization of acidic hydrolysis catalysts, allows sol-gel systems to be prepared which are stable on storage for months, but contain solvent. It is also known that increasing the amount of water leads to full hydrolysis of the alkoxy groups and hence to a drastic reduction in the storage stability of the systems, and/or to rapid formation of gel after the end of the hydrolysis process, more particularly when such systems are intended to have a very high solids content.

German patent application 10 2004 037 045.1, as yet unpublished, relates to a specific sol-gel coating material which can be used inter alia for protecting metal surfaces from corrosion.

It was an object of the present invention to provide a further possibility for corrosion control on metals.

This object is achieved in accordance with the invention as specified in the claims.

Thus it has been found, surprisingly, that a metal surface, preferably aluminum, aluminum alloys, or steel, including galvanized steel and stainless steel, can be better protected from corrosion by

first applying a sol-gel coating material (also referred to below as sol-gel system, sol-gel composition, or composition for short) which is based at least on the components (i) a glycidyloxypropylalkoxysilane, (ii) a colloidally disperse, aqueous silica sol having a solids content of >1% by weight, preferably >20% by weight, more preferably >30% by weight, (iii) an organic acid as hydrolysis catalyst, more particularly acetic acid, propionic acid or maleic acid, and (iv) zirconium tetrapropoxide [also referred to as n-propyl zirconate: Zr(O—C₃H₇)₄], butyl titanate, more particularly n-butyl titanate [Ti(O—C₄H₉)₄], or titanium acetylacetonate as crosslinker to a suitably cleansed metal surface, and drying and curing the sol-gel film—at this stage the thickness of the film is preferably 0.1 to 10 μm—and subsequently applying one or more films to the cured film, and likewise drying and curing them. The further coat or coats applied to the sol-gel coat may advantageously be coatings based on organic resins, or may be further sol-gel coatings or hybrid coatings, examples being those sol-gel systems that have been modified with organic resins. Mention may be made here preferably—but not exclusively—of coatings based on polyester resins, polyether resins, acrylate resins, epoxy resins, alkyl resins, melamine resins, urethane resins, or mixtures thereof, as water-based or solvent-based liquid systems or solvent-free powder coating systems. Applied to the sol-gel coat with particular preference is a topcoat based on one of the aforementioned organic resin systems, more particularly a polyester resin.

As a result of the thin, inventive sol-gel coating of the metal surface it is possible, surprisingly, to achieve a further distinct improvement in the corrosion-inhibiting action of a surface coating system. Moreover, the adhesion of the topcoating system to the metal substrate is distinctly improved by the sol-gel coat. Even the sol-gel coat alone shows an excellent anticorrosive action, which can be utilized as a form of temporary corrosion control on metal surfaces, as, for example, when primed metal substrates are in storage prior to final utilization or final coating.

Through the selection of further specific additives—cf. components (v) and (vi) below—it is possible further to improve the performance of the present sol-gel coating. Suitable additives include, more particularly, phosphoric acid, phosphates, heteropolyacids and their salts, aqueous dispersions of organic binders, more particularly aqueous acrylate dispersions, and inorganic nanoparticles, preferably pyrogenically produced nanoparticles, more particularly fumed silica, i.e., pyrogenically prepared silica (Aerosil®), and also aminoalkylsilanes and aminoalkylsiloxanes, including their aqueous solutions.

The present invention accordingly provides a process for producing a corrosion control coat on a metal surface which involves

a) applying a sol-gel composition based on the reaction of at least the following components
(i) a glycidyloxypropylalkoxysilane,
(ii) an aqueous silica sol having an SiO₂ content of >1% by weight,
(iii) an organic acid as hydrolysis catalyst, and
(iv) n-propyl zirconate, butyl titanate or titanium acetylacetonate as crosslinker to the optionally pretreated, i.e., cleaned, metal surface and drying and/or curing the applied film, and
   b) subsequently applying at least one further film to the sol-gel coat, and drying and/or curing said film.

Advantageously it is possible in step a) of the process of the invention to use a sol-gel composition which is based on at least one further component (v) from the series tetraalkoxysilane, alkylalkoxysilane, and phenyltrialkoxysilane.

It is likewise possible advantageously in step a) of the process of the invention to use a sol-gel composition which is based on at least one further component (vi) from the series of phosphoric acids, phosphates, polyacids and heteropolyacids, salts of polyacids and heteropolyacids, aqueous dispersions of organic binders, flow control assistants, wetting agents, nanoparticles, surfactants, aminoalkylsilanes, and aminoalkylsiloxanes.

Further, it is possible advantageously in step a) of the process of the invention to use a sol-gel composition which has a pH of 6 to 9, preferably 7 to 8, the pH generally being set by addition of a water-soluble base. Suitable for that purpose, for example, are ammonia or organic amines, and also, with particular advantage, from the series of additives as per (vi), aminosilanes, such as

### H₂N—(CH₂)₃—Si(OCH₃)₃ (AMMO)

### H₂N—(CH₂)₃—Si(OC₂H₅)₃ (AMEO)

### H₂N—(CH₂)₂—NH—(CH₂)₃—Si(OCH₃)₃ (DAMO)

### H₂N—(CH₂)₂—NH—(CH₂)₃—Si(OC₂H₅)₃ (DAEO)

### H₂N—(CH₂)₂—NH—(CH₂)₂—NH—(CH₂)₃—Si(OCH₃)₃ (TRIAMO)

### (OCH₃)₃Si—(CH₂)₃—NH—(CH₂)₃—Si(OCH₃)₃ (BisAMMO)

### (OCH₃)₃Si—(CH₂)₃—NH—(CH₂)₃—Si(OC₂H₅)₃ (BisAMEO)

or aqueous solutions of the respective aforementioned aminoalkylsilanes, such as Dynasylan® 1122 or Dynasylan® 1124, or so-called aminoalkylsiloxanes, more particularly aqueous preparations, such as Dynasylan® 1151, or so-called Hydrosils, based on at least one of the aforementioned aminoalkylsilanes, of the kind described in more detail later on below.

It is furthermore possible to dilute a present composition, as used in step a), additionally with water, preferably DI (fully demineralized) water.

Also provided with the present invention is a corrosion control coat on a metal surface that is obtainable by the process of the invention.

The preparation of a sol-gel coating material used in accordance with the invention as per step a) is generally accomplished by mixing the components under hydrolysis conditions, and is described here and also in DE 10 2004 037 045.1 at length.

With certain methods of application, such as spraying or dipping, the application of thin coats requires that the sol-gel system be applied in relatively highly diluted solution. Some of the sol-gel systems DE 10 2004 037 045.1 describes lack adequate water-dilutability. Highly diluted systems may exhibit precipitation and also sedimentation on storage, more particularly when the temperature is slightly elevated. This disadvantage can be avoided, advantageously, by specifically setting the ratio of components (ii) and (i) in the synthesis of the sol-gel system. At a mass ratio R, where R=mass of solids of component (ii)/mass of component (i), of 0.75 or below, it is possible advantageously to prepare sol-gel systems which more particularly are water-dilutable and in dilute form are storage-stable.

The sol-gel coat can be applied to the metal substrate, generally, in a variety of ways. Suitable methods generally include all of the methods that are suitable for liquid coating materials in the painting sector, such as spraying, injecting, spreading, rolling, dipping, and knifecoating. It is preferred to aim for dry coat thicknesses of 0.1 to 10 μm, with particular preference being given to dry coat thicknesses of 1 μm or below. The sol-gel coat generally dries in air to form coatings which are firm to the touch. Aftercrosslinking may take place at elevated temperature. It is preferred first to dry the sol-gel coat, applied to a metal surface, at room temperature for a few minutes, preferably 0.5 to 100 minutes, more preferably 1 to 20 minutes, very preferably 5 to 10 minutes, before carrying out, advantageously, a thermal completion cure, preferably at 100 to 400° C., more preferably at 150 to 250° C., very preferably at 180 to 220° C. Depending on temperature, the time for the completion cure may vary between a few seconds, days, and weeks. Preferably it is between 0.5 to 60 minutes, more preferably between 0.5 to 20 minutes. Curing under forced-air conditions, as in a forced-air drying oven, for example, at a temperature of 200 to 220° C. within a period of 5 to 20 minutes has proven particularly appropriate.

The further coat or coats as per step b) can be applied to the present sol-gel coat in conventional manner, most appropriately in accordance with the instructions of the manufacturer for the coating system in question. There are no restrictions as to the application method or coating system, subject to the proviso that a temperature of 400° C. must not be exceeded for the completion curing of the coating system.

For the sol-gel coating composition, component (i) is preferably selected from the series 3-glycidyloxypropyltrimethoxysilane, 3-glycidyloxypropyltriethoxysilane, 3-glycidyloxypropyl-methyldimethoxysilane, 3-glycidyloxypropylmethyldiethoxysilane or a mixture of at least two of the aforementioned silanes.

As component (ii) preference is given to a usually cationic, colloidally disperse silica sol having a solids content of >1°/0 to 50% by weight, more preferably 20% to 50% by weight, very preferably of 30 to <50% by weight, more particularly of 40% to <50% by weight, i.e., around 45% by weight, the solids content being determined in accordance with DIN EN ISO 3251. Preferred aqueous silica sols more particularly have a pH of 3 to 5, more particularly of 3.5 to 4. Alternatively it is possible to use alkalinically or neutrally stabilized silica sol. Furthermore, silica sols used in accordance with the invention may also contain, as well as amorphous, aqueous SiO₂ particles, further sol-gel-forming aqueous element oxides, such as aluminum oxides or silicon/aluminum oxides or titanium oxides or zirconium oxides or zinc oxide, or a mixture of at least two of the aforementioned oxides. Additionally, preferred silica sols generally contain amorphous, aqueous oxide particles having an average particle size of 40 to 400 nm: for example—but not exclusively—Levasil® 200S/30% and Levasil® 100S/45%.

The pH can be determined in a known way, as for example by means of pH paper, pH sticks or pH electrodes. Further, the particle size distribution in such sol or sol-gel systems can be determined conventionally by means of laser diffraction (Coulter LS particle size measuring instrument).

Furthermore it is possible with advantage, in step a) of the process of the invention, to use a sol-gel composition based on the reaction of at least the following components:

(i) a glycidyloxypropylalkoxysilane,
(ii) an aqueous silica sol having a solids content of >1% by weight,
(iii) an organic acid as hydrolysis catalyst, and
(iv) n-propyl zirconate, butyl titanate or titanium acetylacetonate as crosslinker,
starting from a mass ratio of the solids mass of component (ii) to component (i) ≦0.75, preferably 0.1 to 0.7, more preferably 0.2 to 0.6, more particularly 0.3 to 0.5. Further, a composition of this kind may also be based on additional components (v) and (vi). A particular feature of such specific compositions is that they are dilutable with water in virtually any proportion and also that the highly water-diluted systems are stable on storage for more than four months. Sol-gel systems of this kind find application in accordance with the invention more particularly when the desire is to produce a comparatively thin sol-gel coat on a substrate, preferably for coat thicknesses of 0.1 to 5 μm, more preferably those of around 1 μm or thinner.

Further preference is given, in a composition used in accordance with the invention, to an organic acid from the series acetic acid, propionic acid, and maleic acid as component (iii). Thus a composition contains preferably 0.01% to 3% by weight of component (iii), more preferably 0.5% to 2% by weight, more particularly 1% to 2% by weight, based on the composition.

The crosslinker of component (iv) may be used as a powder, as a liquid or in alcoholic solution for the preparation of the composition. Present compositions are based preferably on a component (iv) content of 0.5% to 8% by weight.

For compositions of the invention it is also possible, as a further component (v), to use, advantageously, a tetraalkoxysilane, more particularly tetraethoxysilane, at least one alkylsilane, suitably an alkylalkoxysilane, more particularly dimethyldiethoxysilane or methyltrimethoxysilane, and/or at least one phenyltrialkoxysilane, more particularly phenyltriethoxysilane or phenyltrimethoxysilane.

Accordingly a composition of the invention may contain component (v) in an amount of 1% to 10% by weight, based on the composition. In this case, suitably, a fraction of component (ii) is replaced correspondingly by component (v).

Furthermore, the performance of the sol-gel coating may be improved further by selection of further specific additives or components (vi). Particularly suitable further additives or components (vi) in the coating material as per step a) include phosphoric acid, phosphates, such as alkali metal phosphates, examples being NaH₂PO₄, Na₂HPO₄, Na₃PO₄, or corresponding cation salts, polyacids and/or heteropolyacids and their salts, such as chromic acid, molybdic acid, chromates, examples being alkali metal and alkaline earth metal chromates and dichromates, calcium molybdate, and molybdophosphoric acid, to name but a few, and aqueous dispersions of organic binders, more particularly aqueous acrylate dispersions, such as methyl methacrylate/n-butyl acrylate dispersions, an example being Plextol® D 510, and nanoparticles, preferably inorganic nanoparticles, more preferably pyrogenically produced nanoparticles, more particularly fumed silica, i.e., pyrogenically prepared silica (Aerosil®), and also aminosilanes and aminoalkylsiloxanes, as already mentioned above.

Thus as further component(s) (vi) for said composition it is possible to use additives which further improve the flow properties and the corrosion control properties. Suitable additives (vi) are flow control assistants and wetting additives, of the kind typically used in the paints and coatings industry, and also phosphoric acid or its salts in a concentration of 0.001% to 1% by weight, preferably 0.01% to 0.1% by weight, more preferably 0.03% to 0.06% by weight, or aqueous resin dispersions, more particularly acrylate dispersions, more preferably aqueous methyl methacrylate/n-butyl acrylate dispersions, in a concentration of preferably 0.1% to 50% by weight, more preferably 1% to 40% by weight, very preferably 10% to 30% by weight, or nanoparticles, preferably produced pyrogenically, more particularly fumed silica in a concentration of 0.01% to 20% by weight, preferably 1% to 10% by weight, based in each case on the sol-gel composition.

Further, the stability of an extant coating material, which may be in a highly diluted form, i.e., of a sol-gel composition, can be additionally improved further by setting of the pH at 6 to 9, preferably 7 to 8, as already described above.

The present compositions are, in general, slightly turbid to opalescent fluids and are distinguished surprisingly by sol particles having an average diameter of 40 to 200 nm, preferably of 50 to 100 nm. The diameter of the sol particles can be determined in a known way, for example, by means of laser diffraction. It is particularly surprising in this context that the compositions, advantageously, also possess a virtually unchanged particle size distribution over a storage time of more than 3.5 months, i.e., are storage-stable.

Moreover, the present compositions are notable advantageously for a solids content of >0.5% to <60% by weight, preferably 20% to 55% by weight, more particularly 25% to 50% by weight, based on the overall composition. The solids content of the present compositions is suitably determined by a method based on DIN ISO 3251. Further, the solids content and also the viscosity of the present compositions can be set by addition of water. In that case the addition of water is advantageously measured so as to give a solids content of approximately 0.5% to 50% by weight. Compositions of the invention of this kind are generally and advantageously stable on storage for several months.

Furthermore, said sol-gel compositions are distinguished by a comparatively low hydrolysis alcohol content of <5% by weight, preferably <3% by weight, more preferably <1% by weight, based on the composition. The alcohol content of a composition of this kind may be determined by means, for example, of gas chromatography in a conventional way.

The storage stability can be additionally prolonged by adding, in addition to water, a particularly suitable organic solvent: for example, ≦10% by weight of 1-methoxypropan-2-ol. Thus said compositions may advantageously have a 1-methoxypropan-2-ol content of ≦10% by weight, preferably 5% to 10% by weight, based on the overall composition. Such systems are generally also distinguished by a high flash point.

The aqueous compositions used as per step a) of the process of the invention preferably have a water content of around 99.5% to 30% by weight, more preferably of 80% to 50% by weight, based on the overall composition. In the case of a fraction of around >50% of water as solvent, a determination is generally made for coating compositions of this kind of the “nonvolatiles content”. This determination is made typically by evaporating the water and also alcohol in accordance with DIN EN ISO 3251—“Determination of the amount of nonvolatile components”. For this purpose the material is generally conditioned at 125° C. for 1 hour in a disposable aluminum dish, and the nonvolatiles content is determined by differential weighing. The determination method is employed predominantly for coating materials, binders for coating materials, polymer dispersions, condensation resins, polymer dispersions with fillers, pigments, and so on. This method yields relative values. Accordingly, in compositions used in accordance with the invention, preference is given more particularly to a nonvolatiles content of 0.5% to 50% by weight.

Said compositions may further advantageously contain at least one surfactant. In particular it is possible in this way, through the addition of a silicone surfactant, such as BYK-348 (polyether-modified polydimethylsiloxane), for example, to achieve an additional improvement in substrate wetting, which can make an advantageous contribution to avoiding flow problems associated with the production of coatings, more particularly on metallic substrates. Preference is given in general to a surfactant content of <0.5% by weight, more particularly of 0.1% to 0.3% by weight, based on the composition.

It is further possible to add so-called Hydrosil systems to said sol-gel compositions as per step a) of the process of the invention.

By Hydrosil systems are meant here essentially water-based, chloride-free, predominantly slightly acidic, aqueous systems which contain a mixture of water-soluble, almost completely hydrolyzed (fluoro)alkyl-/aminoalkyl-/hydroxyl- (and/or alkoxy-)siloxanes, as may be seen, for example, from EP 0 716 127 A, EP 0 716 128 A, EP 0 846 717 A, and EP 1 101 787 A. Examples include Dynasylan® HS 2909, Dynasylan® HS 2775, Dynasylan® HS 2776, and Dynasylan® HS 2627. Particularly advantageous is the addition of Dynasylan® F 8815 to a present composition in a weight ratio of 1:0.01 to 0.01:1, more preferably of around 1:0.1 to 0.1:1, the aqueous Dynasylan® F 8815 used here preferably having an active-compound content <40% by weight, more preferably of 0.1% to 20% by weight, more particularly of around 13% to 15% by weight, based on the composition, and determined in accordance with DIN EN ISO 3251, as described above. Compositions obtained accordingly are advantageously notable on application for highly hydrophobic and oleophobic properties (also referred to as “easy to clean”) on the part of the coating.

Thus preference is likewise given in step a) of the process of the invention to a sol-gel composition for which the basis is components (i) to (iv) and also, where used, (v) and, where used, (vi), and with addition of a Hydrosil system, in a weight ratio of 1:0.01 to 0.01:1, the Hydrosil system used here preferably containing said siloxanes—i.e., active compounds—at <80% by weight, more preferably <40% by weight.

Generally speaking, a composition used in accordance with the invention is prepared by initially introducing component (i), first metering in (iii), thereafter metering (iv), and subsequently adding (ii); the ratio of component (ii) to component (i) is preferably specified in a targeted way, and further component(s) added are (v), if desired, components (vi), and also, if desired, a diluent. An additional diluent which can be used is water, methanol, ethanol and/or 1-methoxypropan-2-ol and also further alcohols.

The reaction in this case is preferably carried out at a temperature of 0 to 35° C., more preferably at 5 to 25° C., for a period of 1 to 60 minutes, more preferably over 5 to 20 minutes, and the resulting product mixture is suitably left to afterreact at a temperature of around 35 to 85° C., preferably at 50 to 60° C. or 60 to 70° C., i.e., preferably somewhat below the boiling point of the hydrolysis alcohol, for 10 minutes to 4 hours, more preferably for 30 minutes to 3 hours. Reaction and afterreaction are generally carried out with thorough mixing, as for example with stirring.

Subsequently it is possible to remove the hydrolysis alcohol formed in the reaction, more particularly methanol, ethanol and/or n-propanol, from the resulting product mixture system by distillation under reduced pressure, and, if desired, to replace the amount of alcohol removed by a corresponding amount of water.

An additional possibility is to add a surfactant to the reaction mixture or product mixture, for example—but not exclusively—BYK 348, and to add the further additives described.

An alternative option is to dilute the resulting product mixture, which is generally slightly turbid to opalescent, and/or to set the desired solids content, where possible, using water and/or 1-methoxypropan-2-ol or other alcohols.

The pH of such a system can be set, further, at 6 to 9.

Additionally it is possible to add a Hydrosil, preferably one with a fluoro-functional or alkyl-functional active compound, to the present product mixture and/or to the present composition. In that case, more particularly, a Hydrosil concentrate is added in an amount of 13 to 15% by weight, calculated as active compound and based on the subsequent composition, with thorough mixing.

In the process of the invention, in step b), atop a sol-gel coat as per step a), at least one further coat from the series of organic resins or further sol-gel coating systems will be produced.

Thus, in the process of the invention, in step b), at least one further coat is produced based on conventional coating systems, as for example on a polyester resin, polyether resin, acrylic resin, epoxy resin, alkyl resin, melamine resin, urethane resin, a mixture of at least two of the aforementioned resins, and also aforementioned resins as water-based or solvent-based liquid systems or solvent-free powder coating systems; sol-gel systems or sol-gel hybrid systems are also suitable.

The curing, or drying with subsequent curing, is carried out preferably thermally and/or photochemically on the coats produced in accordance with the invention in steps a) and b).

A specific sequence of coats, i.e., coating, obtainable by the process of the invention, is notable in an outstanding way as a corrosion control coat for a metal surface. Sol-gel coats obtainable as per step a) are additionally notable for outstanding primer properties, i.e., as adhesion promoters.

The present invention accordingly further provides a coating on a metal surface, i.e., a sequence of coats on metal, characterized by
I) a sol-gel coat present on the metal surface and obtainable by coating of the metal with a sol-gel composition,
   the sol-gel composition being based on the reaction of at least the following components:
   (i) a glycidyloxypropylalkoxysilane,
   (ii) an aqueous silica sol having an SiO₂ content of >1% by weight,
   (iii) an organic acid as hydrolysis catalyst, and
   (iv) n-propyl zirconate, butyl titanate or titanium acetylacetonate as crosslinker,
      and
      II) at least one further coat applied to the coat as per I).

Preference is given, for this coating, as per II), to at least one coat based on a polyester resin, polyether resin, acrylic resin, epoxy resin, alkyl resin, melamine resin, urethane resin, on a mixture of at least two of the aforementioned resins, and also on aforementioned resins as water-based or solvent-based liquid systems or solvent-free powder coating systems.

Generally speaking, a corrosion control coat of the invention can be produced on a metal surface as follows:

Generally speaking, a composition used in accordance with the invention is prepared by initially introducing component (i), first metering in (iii), thereafter metering (iv), and subsequently adding (ii); the ratio of component (ii) to component (i) is preferably specified in a targeted way, and further component(s) added are (v), if desired, components (vi), and also, if desired, a diluent. Additives under component (vi) are preferably added at the end. If a component (v) is used, it is used preferably at a point in the preparation when component (i) as well is used. The metering of the components and their reaction take place typically with thorough mixing.

Through a high fraction of silica sol it is possible to introduce substantially more water into the mixture than is necessary for the hydrolysis of the silane under (i) and also (v). As hydrolysis sets in, there is generally a slight increase in the temperature of the reaction mixture. In that case it is possible to carry out additional cooling or, where necessary, gentle heating. Appropriately the reaction mixture or product mixture is allowed to afterreact for a certain time at a slightly higher temperature with stirring. Following the reaction, then, the product is generally a hydrolyzate with a copious amount of water and also hydrolysis alcohol, methanol, ethanol, or n-propanol for example. In general the hydrolyzate is storage-stable at least for a limited time. Hydrolysis is also accompanied by the start of slow condensation of the silane molecules with one another, but also with OH groups on the surface of the SiO₂ particles, which leads to the preliminary formation of an inorganic/organic network, but is generally not accompanied by any deposition of reaction product. Furthermore, the hydrolysis alcohol, especially toxic methanol, can be removed from the resulting product mixture and replaced by corresponding amounts of water. It is also possible with advantage to admix further components (v) and/or (vi) to the present composition, examples being a surfactant, and also further amounts of water, 1-methoxypropan-2-ol, and a Hydrosil mixture, to name but a few examples. In the case of a high ratio of component (ii) to (i), the water-dilutability is generally restricted, and in that case the diluted solutions are less storage-stable. In order to attain low dry coat thicknesses <10 μm, it is necessary with certain forms of application, such as dipping or spraying, for example, for the dry residue to be reduced sharply by means of solvents. If, in this case, water rather than any organic solvents is to be used, then it has surprisingly been found that highly water-dilutable and at the same time storage-stable sol-gel compositions can be prepared by setting a relatively low mass ratio of the mass of solids of component (ii) to component (i): R=mass of solids of component (ii)/mass of component (i). At a ratio R≦0.75 such highly water-dilutable and, in dilution, storage-stable sol-gel coating compositions are made advantageously possible.

Furthermore, by an appropriate addition (v) of dimethyldiethoxysilane, it is possible to improve the hydrophobic effect and the elasticity of the coating. By adding phenylalkoxysilane when preparing the present coating material of the invention it is possible to exert an advantageous influence both on the thermal stability and on the elasticity of such a coating. The addition of methyltriethoxysilane has the advantageous effect of improving the hydrophobic properties of the coating. Furthermore, the scratch resistance and abrasion resistance can be further improved more particularly by adding tetraethoxysilane when preparing the coating material.

Formation of fly rust on acid-sensitive substrates, such as steel, can be largely prevented if the pH is set to 7 or slightly above. For that purpose it is possible to add basic additives to the sol-gel system. Suitability is possessed in principle by all water-soluble bases, but particularly by basic amines, very particular suitability being enjoyed by basic aminosilanes and also basic aminosilane hydrolyzates, such as Dynasylan® 1151 (Degussa), for example.

The metal surface for protection is generally first cleaned, more particularly degreased, prior to coating, in accordance with methods which are commonplace in the painting industry. Thus a metal surface may be treated thermally, chemically or mechanically, as for example by heating, sputtering, irradiating, etching, by means of organic solvents, sandblasting, polishing, and so on.

A sol-gel coating composition as described above can be employed by application to a substrate, by means, for example, of brush application, injecting, spraying, knifecoating or dipping, to name but a few of the possibilities. Following application, the coating is typically dried for a short time and may then be subjected to thermal aftertreatment. Thus, after sol-gel coating, it is preferred—but not mandatory—to carry out a thermal treatment at a temperature >150° C. Thus, for example—but not exclusively—controlled knife application of the sol-gel coating composition may be followed, advantageously, by the generation of a transparent, scratch proof coat approximately 0.1 to 5 μm thick, by 10-minute drying at room temperature and 5-minute thermal aftertreatment at around 200° C., on a metal substrate, more particularly an aluminum substrate. It is also possible, after the composition has been applied to the substrate, to flash off the coating for suitably 5 to 15 minutes, preferably around 10 minutes, and, advantageously, to cure it at a temperature in the range between 150 to 220° C. Alternatively, after the sol-gel coat has been dried at room temperature, a further coating may be applied to the sol-gel coat, such as a coil coating, for example, after which the coating system as a whole can be jointly cured thermally. Thus, for example—but not exclusively—the curing may be advantageously carried out under the following conditions: preheat the drying unit, then 30 to 60 minutes at 150° C. or 10 to 30 minutes at 180° C. or around 20 minutes at 200° C. or approximately 10 to 20 minutes at 220° C. In this case it is possible to obtain thicknesses for the sol-gel coat or sol-gel primer of <1 to 15 μm, preferably 0.1 to 10 μm.

It is also possible, however, to apply one or more further coats, preferably coats of surface-coating material, more particularly those based on the stated resins, to the sol-gel coat which has been applied to a metal surface and cured, this subsequent application taking place until the desired sequence of corrosion control coats or the desired decorative effect is achieved. Suitable additional coats of surface-coating material on the present sol-gel coat are generally all commercially customary surface-coating systems. The application of these additional coats may generally take place in accordance with the instructions of the respective manufacturer.

A corrosion control coat of the invention, composed of the sol-gel coat and the topcoat or topcoats applied to it, is suitable more particularly for producing mechanically stable coatings which feature scratch and abrasion resistance, high hydrophobicity, and also chemical resistance, and which have a further improved corrosion control effect on metal surfaces.

Thus, advantageously, a corrosion control coat of the invention is produced preferably—but not exclusively—on metals, including metal alloys, such as aluminum, aluminum alloys or steel, including tool steel or galvanized steel, for example, on sheets or shaped parts, in the automotive industry, for example, to name but a few examples.

Likewise provided by the present invention, therefore, are metal articles having a corrosion control coat of the invention.

The present invention further provides for the use of a coat or coating obtainable or produced in accordance with the invention for the protection of a metal surface, more particularly of aluminum, aluminum alloy, or steel, including galvanized steel and stainless steel, from corrosion.

The present invention is illustrated in more detail by the examples which follow, without the subject matter of the invention being restricted.

### EXAMPLES

### Determination of the Solids Content in Coating Materials

In accordance with DIN ISO 3251 the solids content in coating materials is understood to mean the amount of nonvolatile components, the determination being carried out under well-defined conditions.

The solids content of the present coating compositions was determined as follows in a method based on DIN ISO 3251 (QM-AA AS-FA-SL 7001):

A disposable aluminum dish (d=about 65 mm, h=about 17 mm) was charged with approximately 1 g of sample (accuracy 1 mg) on an analytical balance. The product was distributed evenly in the disposable dish by brief swirling. The dish was stored in a drying oven at about 125° C. for 1 hour. After the end of the drying procedure the dish was cooled to room temperature for 20 minutes in a desiccator and back-weighed on the analytical balance to an accuracy of 1 mg. For each experiment it was necessary to carry out at least two determinations and to report the average value.

### Assessment of the Corrosion Properties by a Method Based on DIN 50021 (CASS Test)

The coated metal substrates were placed in the test solution at 50° C. for 24 hours. The metal substrates were completely covered with the corrosive liquid. Thereafter the test substrates were removed from the test solution and the corrosion was assessed visually:

### Assessment Criteria:

+: only isolated traces or no traces of corrosion visible
o: distinct corrosion (pitting) apparent
−: very severe corrosion (pitting) apparent

The test solution was prepared in accordance with DIN 50021 (cf. DIN 50021, page 3, section 5.3, test solution for testing to DIN 50021—CASS).

### Measurement of the Dry Film Thickness

### Test Apparatus:

Dualscope MP4C from Fischer
Dualscope MP40 from Fischer

### Testing:

For measurement of a cured coating, the probe was placed on the paint film and the measurement was read off in μm. Depending on the size of the coated area, a plurality of measurements should be ascertained (3 to 10). As a measure of the scatter it was possible to use the difference between the largest and the smallest value, or the standard deviation. The number of measurements could be read off.

### Calibration:

Prior to each series of measurements, the instrument was investigated by standardization (zero-point determination) on the uncoated article under measurement, with subsequent measurement of a test sheet. If the deviation in the coat thickness measured was >1 μm, a corrective calibration was carried out using a certified test plaque.

### Example 1

### Preparation of Sol-Gel System 1

### Apparatus:

Stirred reactor with distillation apparatus, vacuum pump
Metering apparatus, liquid-phase thermometer and overhead thermometer

### Procedure:

415.6 g of Dynasylan® GLYMO were introduced as an initial charge and 20.6 g of acetic acid were added with stirring. Immediately thereafter 41.1 g of TYZOR® NPZ were metered in. After 5 minutes the temperature had risen by about 2 to 5° C. At that point 417.0 g of Levasil® 100S/45°/0 (aqueous silica sol with a solids content of 45% by weight) were stirred in over the course of 1 minute. A good stirring action was ensured. Immediately thereafter 477.3 g of DI water were added dropwise, again rapidly. When the maximum temperature (about 42° C.) was reached, the opaque dispersion was stirred further at 75 to 80° C. (reflux) for 2 hours. After the dispersion had cooled to liquid-phase temperature of approximately 50° C., a further 356.4 g of DI water were metered in. Subsequently the methanol was distilled off at a liquid-phase temperature of approximately 50 to 60° C. and an absolute pressure of approximately 270 mbar. At the end of the distillation the liquid-phase temperature rose to 60 to 65° C. with unchanged pressure. The overhead temperature likewise rose to >62° C. At that point only water was distilled off, and the distillation was therefore ended. After the dispersion had cooled to ≦50° C., the amount of DI water removed by distillation, which was >59.4 g, was replenished. The dispersion was stirred further for at least 2 hours. It was discharged at RT.

The product had a milkily opaque appearance.

The ratio R=solids mass of component (ii)/mass of component (i) was 0.45.

### Final Mass:

Yield virtually 100%: 1 498 g

The physicochemical properties of the product were as follows:

| Solids content (1 h 125° C.) | 36% by weight | (based on DIN |
|---|---|---|
| | | ISO 3251) |
| SiO₂ content | approx. 16% by weight | (AN-SAA 1653) |
| pH | 4-5 | |
| Density (20° C.) | 1.148 g/ml | (DIN 51757) |
| Viscosity (20° C.) | approx. 8 mPa s | (DIN 53015) |
| Methanol after hydrolysis | <3% | (AN-SAA 0272) |

### Example 1a

### Preparation of Sol-Gel System 1a

### Apparatus:

Stirred reactor with distillation apparatus
Metering apparatus
Internal thermometer

### Procedure:

363.6 g of Dynasylan® GLYMO were introduced as an initial charge and 18.0 g of acetic acid were added with stirring. Immediately thereafter 36.0 g of TYZOR® NPZ were metered in. After 5 minutes the temperature had risen by about 2 to 5° C. At that point 782.4 g of Levasil® 100S/45°/0 were stirred in over the course of 3 minutes. A good stirring action was ensured. When the maximum temperature (10 minutes after the end of the addition of the silica sol) was reached, the opaque dispersion was stirred further at 75 to 80° C. (reflux) for 2 hours. After the dispersion had cooled to liquid-phase temperature of approximately 50° C., 312.0 g of DI water were metered in. Subsequently the methanol was distilled off at a liquid-phase temperature of approximately 50 to 60° C. and an absolute pressure of approximately 270 mbar. At the end of the distillation the liquid-phase temperature rose to 63 to 65° C. with unchanged pressure. The overhead temperature likewise rose to >62° C. At that point only water was distilled off, and the distillation was therefore ended. After the dispersion had cooled to ≦50° C., the amount of water removed by distillation was replenished. The dispersion was stirred further for approximately 2 hours.

The product had a milkily opaque appearance.

The ratio R=solids mass of component (ii)/mass of component (i) was 0.96.

### Final Mass:

Yield virtually 100%: 1 364 g

### Analyses:

| Determination | Result | Method |
|---|---|---|
| Viscosity | <100 mPa s | DIN 53015 |
| Density | 1.24-1.25 g/ml | DIN 51757 |
| Solids | 46%-49% | based on DIN ISO 3251 |
| pH | 4.7-5.0 | |
| SiO₂ | 27-30% | AN-SAA 1653 |
| Methanol after hydrolysis | <3% | AN-SAA 0272 |

### Example 2

### Use of Phosphoric Acid as Additive

Plates of chrome tool steel were coated with the following products:
a) mixture of 50% by weight of sol-gel product from Example 1a and 50% by weight of DI water (=fully demineralized water),
b) mixture of 33.3% by weight of sol-gel product from Example 1a, 33.3% by weight of DI water, and 33.3% by weight of phosphoric acid (w=0.15). The concentration of phosphoric acid in the mixture was therefore approximately 0.0499% by weight.

Within 2 hours after the preparation of the mixtures, the sol-gel coating systems were applied using a 4 μm knife. Drying conditions: 10 minutes at 23° C. at 52% rh, and 10 minutes at 200° C. in a forced-air drying oven. Glossy, homogeneous coatings were obtained with dry coat thicknesses of 1.5 and 0.3 μm respectively.

The samples were each scored down to the substrate material and then immersed in 1% strength NaCl solution for 5 minutes. This was followed by storage in the controlled-climate chamber at 40° C. and 82% relative humidity (rh). After an exposure time of 49 days, the picture which emerged was as follows: the sample coated with a) exhibited severe surface corrosion, while the sample coated with b) exhibited only slight surface corrosion and only a little filiform corrosion.

### Example 3

### Use of Plextol® D510 as Additive

Plates of sheet test aluminum (Q-panel 3105H24) were coated with the following products:
a) sol-gel product from Example 1a,
b) mixture of 70% by weight of sol-gel product from Example 1a and 30% by weight of Plextol® D510 (aqueous methyl methacrylate/n-butyl acrylate dispersion from Polymer Latex).

Within 2 hours after the preparation of the mixture, it was applied using a 4 μm knife. The dry coat thickness in both cases was <1 μm. Drying/curing conditions: 10 minutes at room temperature (23° C.) with subsequent curing at 220° C. (product b) or 200° C. (product a) in a forced-air drying oven (10 to 20 minutes). The corrosion performance was assessed by means of the CASS test (for result see table below):

| Product from Example 1a | Plextol ® D510 | CASS test assessment |
|---|---|---|
| 100% | 0% | − |
| 70% | 30% | + |

### Example 4

### Use of Aerosil® 380 as Additive

Plates of sheet test aluminum (Q-panel 3105H24) were coated with the following products:
a) sol-gel product from Example 1a,
b) mixture of 88% by weight of sol-gel product from Example 1a, 10% by weight of DI water, and 2% by weight of Aerosil® 380 (fumed silica from Degussa),
c) mixture of 83% by weight of sol-gel product from Example 1a, 10% by weight of DI water, and 7% by weight of Aerosil® 380 (fumed silica from Degussa).

Within 2 hours after the preparation of the mixture, it was applied using a 4 μm knife. The dry coat thickness in both cases was <1 μm. Drying/curing conditions: 10 minutes at room temperature (23° C.) with subsequent curing at 220° C. in a forced-air drying oven (10 minutes) in the case of b) and 200° C. in the case of a) and c) (10 minutes). The corrosion performance was assessed by means of the CASS test (for result see table below):

| Product from Example 1a | Aerosil ® 380 | CASS test assessment |
|---|---|---|
| 100% | 0% | − |
| 88% | 2% | + |
| 83% | 7% | + |

### Example 5

### Sol-Gel System from Example 1a in Comparison to Commercial Primers and Adhesion Promoters

Aluminum substrates (aluminum test panel, alloy 3105H24), steel substrates (cold-rolled steel S36), and substrates made from galvanized steel sheet were treated with the following coating systems:
a) sol-gel system from Example 1a,
b) TU universal primer [solvent-based (650 g/l VOC) universal primer from Relius],
c) Bonderite NT 1 (heavy metal-free and phosphate-free reactive conversion coating from Henkel).

Product a) was applied to all the substrates using a 4 μm knife (dry coat thickness <1 μm). Drying conditions: 10 minutes at room temperature (23° C.) and subsequently 20 minutes at 220° C. in a forced-air drying oven. Product b) was applied using a 100 μm knife, dried at room temperature for 10 minutes and after crosslinked for 10 minutes at 140° C. in accordance with the manufacturer's recommendation. In accordance with the manufacturer's recommendations, product c) was applied at room temperature (23° C.) via dipping (dipping time 10 minutes), dried at room temperature for 5 minutes and then dried further at 180° C. for 10 minutes.

The substrates thus treated were subsequently immersed for 24 hours at 50° C. in the CASS test solution described above, after which they were rinsed off with water and assessed for corrosion. The picture which emerged was as follows:

Product b) (solventborne high-build primer), as expected, showed no corrosion at all on any substrate. Disadvantages associated with this primer, however, were the solvent content and the high quantity consumed, of approximately 100 ml/m² (100 μm wet film thickness).

Product a) (sol-gel system according to Example 1a) showed only isolated local corrosion on the aluminum substrate and the galvanized steel panel, and corrosion of approximately 60% of the total area in the case of the steel substrate, with a very low amount consumed, of only about 4 ml/m² (4 μm wet film thickness).

Product c) exhibited very severe corrosion on all the substrates (in each case 100% of the area which had come into contact with the test solution was corroded).

### Example 6

### Sol-Gel System from Example 1a as a Primer Under a Coil Coating

Galvanized steel panels were precleaned with ethyl acetate and then coated with the following products:
a) mixture of sol-gel product from Example 1a (80% by weight), water (19.7% by weight), and flow control assistant BYK 348 (0.3% by weight), substrate a);
b) mixture of sol-gel product from Example 1a (50% by weight), water (20% by weight), and Plextol® D510 (50% by weight), substrate b).

Application took place using a 4 μm knife, drying conditions: 10 minutes at room temperature (23° C.) and then 20 minutes at 220° C. The substrates coated with products a) and b) and dried were subsequently painted with a standard polyester paint (from Degussa) and, after curing (30 seconds, 232° C.), were subjected to a salt fog test in accordance with DIN 50021. Included in the test was a galvanized steel panel which had been pretreated with a standard polyester-based primer (5 μm dry film thickness) and topcoated with the same polyester paint as described under a), b), and cured under the same conditions (substrate c).

Prior to the performance of the salt fog test, all of the samples were scored with a cross pattern down to the substrate material. After 500 hours of salt fog exposure, the picture which emerged was as follows:

Substrate a): at the cross-shaped score mark there was corrosion-induced undermining of the coating for up to 43 mm. In the area not damaged by scoring, there was undermining of the coating for up to 5 mm at about six locations.

Substrate b): at the cross-shaped score mark there was corrosion-induced undermining of the coating for only up to 15 mm. In the area not damaged by scoring, there was undermining of the coating for only up to 2 mm at about two locations.

Substrate c) (standard system): at the cross-shaped score mark there was corrosion-induced undermining of the coating for up to 18 mm. In the area not damaged by scoring, there was undermining of the coating for up to 4 mm at about two locations.

Summary: sol-gel system b), surprisingly, came out the best, exceeding the standard system in terms of performance.

### Example 7

### Water Dilutability of the Sol-Gel Compositions from Examples 1 and 1a

The products from Examples 1 and 1a were diluted 1:1 with DI water and stored at 50° C. After a few days of storage a distinct sediment became apparent in the case of the product from Example 1a, but did not occur with the product from Example 1. Summary: only the product from Example 1 was storage-stable in dilution with water. Storage-stable water-diluted products are important for the practical applications of spraying and dipping if low dry coat thicknesses of 1 μm or below are to be attained.

### Example 8

### Dipping Application with a Sol-Gel System from Example 1a

A sandblasted steel panel was immersed in the product obtained in Example 1a and, after an immersion time of 1 minute, was removed again from the dipping bath. The amount retained by the steel panel was approximately 80 g/m². For a solids content of 49% for the product from Example 1a, this gave a dry film thickness of >20 μm. In order to obtain the desired coat thickness of <10 μm, accordingly, it was necessary to carry out dilution with more than 50% water. As observed in Example 7, dilutions to that level of the product from Example 1a were not storage-stable. If a high level of dilution of the sol-gel system was required, it was necessary to switch to dilutable systems according to Example 1 with a reduced silica sol content as compared with products from Example 1a.

### Example 9

### Preparation of a Neutralized Sol-Gel System

The product from Example 1 was charged to a stirred vessel and admixed, with thorough stirring and continual pH monitoring, with Dynasylan® 1151 (aqueous aminosilane hydrolyzate from Degussa). The introduction of Dynasylan® 1151 was continued until the pH had reached the level of 7. The resulting product was stable on storage at a temperature of 54° C. for more than eight weeks.

1. A process for producing a corrosion control coat on a metal surface by
a) applying to the metal surface a sol-gel composition based on the reaction of at least the following components
(i) a glycidyloxypropylalkoxysilane,
(ii) an aqueous silica sol having an SiO₂ content of >1% by weight,
(iii) an organic acid as hydrolysis catalyst, and
(iv) n-propyl zirconate, butyl titanate or titanium acetylacetonate as crosslinker
and drying and/or curing the applied composition, and
b) subsequently applying at least one additional film to the sol-gel coat, and drying and/or curing said film.

2. The process according to claim 1, characterized in that the metal surface is cleaned before step a).

3. The process according to claim 1, characterized in that in step a) a sol-gel composition is used which is based on at least one further component (v) selected from the group consisting of tetraalkoxysilane, alkylalkoxysilane, and phenyltrialkoxysilane.

4. The process according to claim 1, characterized in that in step a) a sol-gel composition is used which is based on at least one further component (vi) selected from the group consisting of phosphoric acids, phosphates, polyacids and heteropolyacids, salts of polyacids and heteropolyacids, aqueous dispersions of organic binders, flow control assistants, wetting agents, nanoparticles, surfactants, aminoalkylsilanes, and aminoalkylsiloxanes.

5. The process according to claim 1, characterized in that in step a) a sol-gel composition is used which has a pH of 6 to 9, the pH being set by addition of a base.

6. The process according to claim 1, characterized in that in step a) a sol-gel composition is used for which the basis is components (i) to (iv) with the addition of a Hydrosil system, in a weight ratio of 1:0.01 to 0.01:1.

7. The process according to claim 1, characterized in that in step a) a sol-gel composition is used having a solids content of 0.5% to <60% by weight, based on the overall composition.

8. The process according to claim 1, characterized in that in step a) a sol-gel composition is used having a hydrolysis alcohol content of <5% by weight, based on the overall composition.

9. The process according to claim 1, characterized in that in step a) a sol-gel composition is used which additionally is diluted with water.

10. The process according to claim 1, characterized in that in step a) a sol-gel composition is used having a water content of 99.5% to 30% by weight, based on the overall composition.

11. The process according to claim 1, characterized in that in step a) a sol-gel composition is used based on the reaction of at least the following components:
(i) a glycidyloxypropylalkoxysilane,
(ii) an aqueous silica sol having a solids content of >1% by weight,
(iii) an organic acid as hydrolysis catalyst, and
(iv) n-propyl zirconate, butyl titanate or titanium acetylacetonate as crosslinker,
starting from a mass ratio of the solids mass of component (ii) to component (i) ≦0.75.

12. The process according to claim 1, characterized in that in step b) at least one additional coat is produced, selected from the group consisting of organic resins or of further and other sol-gel coating systems.

13. The process according to claim 1, characterized in that in step b) at least one additional coat is produced based on a polyester resin, polyether resin, acrylic resin, epoxy resin, alkyl resin, melamine resin, urethane resin, or a mixture of at least two of the aforementioned resins, and also on said aforementioned resins as water-based or solvent-based liquid systems or solvent-free powder coating systems.

14. The process according to claim 1, characterized in that the coatings are cured thermally or photochemically.

15. A corrosion control coat on a metal surface, produced according to the process of claim 1.

16. A coating on a metal surface, characterized by
I) a sol-gel coat present on the metal surface and obtainable by coating of the metal with a sol-gel composition,
said sol-gel composition being based on the reaction of at least the following components:
(i) a glycidyloxypropylalkoxysilane,
(ii) an aqueous silica sol having an SiO₂ content of >1% by weight,
(iii) an organic acid as hydrolysis catalyst, and
(iv) n-propyl zirconate, butyl titanate or titanium acetylacetonate as crosslinker,
and
II) at least one additional coat applied to the coat as per I).

17. The coating on a metal surface according to claim 16, characterized by at least one coat as per II) based on a polyester resin, polyether resin, acrylic resin, epoxy resin, alkyl resin, melamine resin, urethane resin, or a mixture of at least two of the aforementioned resins, and also on said aforementioned resins as water-based or solvent-based liquid systems or solvent-free powder coating systems.

18. A method for protecting a metal surface from corrosion comprising applying a corrosion control coat according to claim 15.

19. The method according to claim 18 wherein said metal surface is selected from the group consisting of aluminum, aluminum alloy, stainless steel and galvanized steel.

20. An article having a corrosion control coat according to claim 15.
